(19) United States
(12) Patent Application Publication
(10) Pub. No.: US 2014/0077600 A1
(43) Pub. Date: Mar. 20, 2014

(54) SYSTEM AND METHOD FOR CONTROLLING ENERGY STORAGE AND DISTRIBUTION

(71) Applicants: Robert Douglas CRYER, Erie, PA (US); Ajith Kuttannair Kumar, Erie, PA (US); Hien Pham, Houston, TX (US); Ramesh K. Krishnan, Mississauga (CA)

(72) Inventors: Robert Douglas CRYER, Erie, PA (US); Ajith Kuttannair Kumar, Erie, PA (US); Hien Pham, Houston, TX (US); Ramesh K. Krishnan, Mississauga (CA)

(21) Appl. No.: 13/617,914

(22) Filed: Sep. 14, 2012

(51) Int. Cl. H02J 3/32

(52) U.S. Cl. 307/48

(57) ABSTRACT

Embodiments relate to a system for controlling the storage and distribution of energy on a drill rig. The system includes a drill rig having a power consuming device, a power source for providing electrical power, a power storage device, and an electrical power bus. The power bus is electrically connected to the power source, the power consuming device, and the power storage device and is configured to provide an electrical pathway between one or more of the power source, power consuming device, and power storage device.

### FIELD OF THE INVENTION

Embodiments of the invention relate generally to energy storage. Other embodiments relate to the distribution of regenerated power.

### BACKGROUND OF THE INVENTION

In the drilling industry, drilling rigs are utilized to drill wells in the earth to extract oil, natural gas, water, and other resources. Drilling rigs utilized for this purpose generally include a derrick consisting of a tower used for lifting and positioning a drill string and piping above a well bore (e.g., using a draw-works), and machinery for driving the drill bit within the bore. In operation, as the drill string goes deeper into the underlying soil or rock, new piping is added to the top of the drill string to maintain the connection between the drill bit and the turning machinery, to create a filler to keep the hole from caving in and to create a conduit for pumping in drilling mud (e.g., using a mudpump). The drilling mud is pumped into the bore through the drill string and is used to cool the drilling bit and to blow debris clear from the drill bit and the bottom of the well. The piping joint sections, each usually about 30 feet long, have threaded ends so they can be screwed together. The piping is hollow to allow for the mud to be pumped down into the drilling hole, which flushes out the drilling bit and proceeds upwards towards the surface on the outside of the drill string, carrying the debris with it.

During drilling, the drill bit will occasionally become dull and require replacement. Replacing a drill bit, referred to as “tripping,” requires lifting the drill string out of the well, changing the drill bit, and lowering the drill string back into the well.

As will be readily appreciated, operations such as drilling and tripping require large quantities of energy, such as, for example, when moving traveling blocks to the top of the derrick while gripping a pipe stand to extract each pipe stand from the well. In connection with this, power generation on drill rigs is typically oversized to ensure that maximum levels of power demand can be achieved. This means, however, that during times when 100% of this power may not be required, there is power that is generated inefficiently or that is wasted. In addition, energy is often wasted as a result of trying to arrest the physics of power-consuming implements, such as the downward fall of the traveling blocks during tripping, to bring them back to a neutral state (e.g., braking, decelerating, or resisting), or the simple process of slowly lowering the drill string into the hole. This energy may often result in frictional heat, or electrical power, which is customarily diverted to resistor grids/load banks where the resultant heat is dissipated to atmosphere. In connection with the power generation necessary for drill rig operation, power generation is also not 100% efficient and results in unwanted by-products such as emissions and noise.

### BRIEF DESCRIPTION OF THE INVENTION

An embodiment of the present invention relates to a control system. The system comprises a drill rig having a power consuming device, a power source for providing electrical power, a power storage device and an electrical power bus. The electrical power bus is electrically connected to the power source, the power consuming device and the power storage device and is configured to provide an electrical pathway between one or more of the power source, power consuming device and power storage device.

In another embodiment, a method for a drill rig is provided. The method includes controlling a flow of electrical power from a power source to a power consuming device of the drill rig and storing electrical power in excess of that consumed by the power consuming device in a power storage device.

Another embodiment of the present invention relates to a control system. The system comprises a source of electrical power, a drill rig having a power consuming implement, a power storage unit, an electrical power bus and a control unit. The electrical power bus is electrically coupled to the source of electrical power, the power consuming implement and the power storage unit, and is configured to provide an electrical pathway between one or more of the source of electrical power, the power consuming implement and power storage unit. The control unit is electrically coupled to the power bus and is configured to selectively control the flow of electrical power between the source of electrical power, the power consuming implement, and the power storage device.

Yet another embodiment of the present invention relates to a control system. The control system comprises a drill rig having a derrick, a draw-works, and traveling blocks for raising and lowering a drill string into and out of a well bore, wherein the draw-works comprises a motor operably coupled to the traveling blocks, a power source at a site of the drill rig for providing electrical power, a power storage device at the site of the drill rig, an electrical power bus electrically connected to the power source, the motor, and the power storage device, and a control unit electrically coupled to the power bus. The control unit is configured to control transfer of at least a portion of the electrical power provided by the power source to the power storage device over the electrical power bus when a capacity of the power source exceeds a power demand of the motor and other loads connected to the power source; control transfer of the electrical power provided by the power source to the motor over the electrical power bus for the motor to raise the traveling blocks; and control transfer of electrical power generated by the motor, from the motor to the power storage device over the electrical power bus, when the motor arrests the fall of the traveling blocks within the derrick during a tripping process of the drill rig.

### BRIEF DESCRIPTION OF THE DRAWINGS

The present invention will be better understood from reading the following description of non-limiting embodiments, with reference to the attached drawings, wherein below:

FIG. 1 illustrates a drill rig according to an embodiment of the invention.

FIG. 2 is a simplified schematic view of a system for controlling energy storage and distributing regenerated power according to an embodiment of the invention.

FIG. 3 is a graph illustrating power usage and regeneration during tripping out of hole for a drilling rig employing the system of FIG. 2.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Although exemplary embodiments of the present invention are described with respect to off-shore drilling rigs and platforms, embodiments of the invention are also applicable for use with drilling rigs generally, including exploration and production rigs, meaning any system and machinery configured to drill a well bore in the earth for the purposes of discovering, locating, and extracting resources.

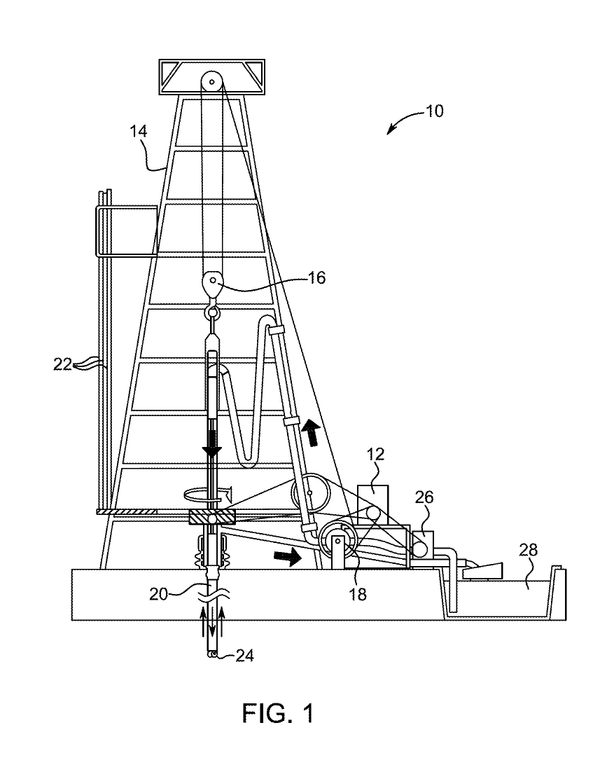

With reference to FIG. 1, the working platform for drilling work is generally referred to as a drilling rig 10. The drilling rig 10 holds most components required for drilling work. The main components include a power system, a hoisting system, a rotary system, and a circulating system. The power system may include one or more engine driven generators 12 which function as a power source to provide electricity to various working components described hereinafter. The hoisting system includes the derrick 14, traveling blocks 16, and a draw-works 18, and functions to lift and lower a drill string 20 to insert or remove pipe stands 22 during drilling or tripping. The rotary system rotates the pipe stand 22 and a drill bit 24 to drill the well, and may include a swivel, a kelly, a rotary drive, and a rotary table. Alternatively, a top-drive may be utilized to rotate the string from above. Finally, the circulating system includes a mud pump 26 that pumps and circulates drilling mud from a mud reservoir 28 and through the drill pipe to remove cuttings from the bottom of the well bore. In addition to the above, drilling rigs also include a well control and monitoring system that controls operation of the various functional components described above in dependence upon detected conditions such as pressure, drill speed, drill depth, weight on bit, rate of penetration, etc. While FIG. 1 illustrates a draw-works 18 that is mechanically driven, embodiments of the present invention are applicable to more modern motor-driven draw-works that function as hoisting machinery to raise and lower the traveling blocks. Indeed, it will be readily appreciated that drilling rigs may differ in their components and configuration depending on the particular application. Regardless of their particular application, however, all include motors or other power generators that drive functional components such as draw-works, top drives, mud pumps, and gensets.

As used herein, “draw-works” means the primary hoisting machinery on a drill rig and includes a draw works motor, and is a means of raising and lowering the traveling blocks. As used herein. “top drive” means a device on a drill rig that provides rotational force to the drill string to facilitate the process of drilling a borehole. As used herein, “mud pump” means any device designed to circulate drilling fluid under high pressure down the drill string and back up to the top of the borehole. As used herein, “genset” means a combination electrical generator and an engine mounted together and configured to provide electrical power.

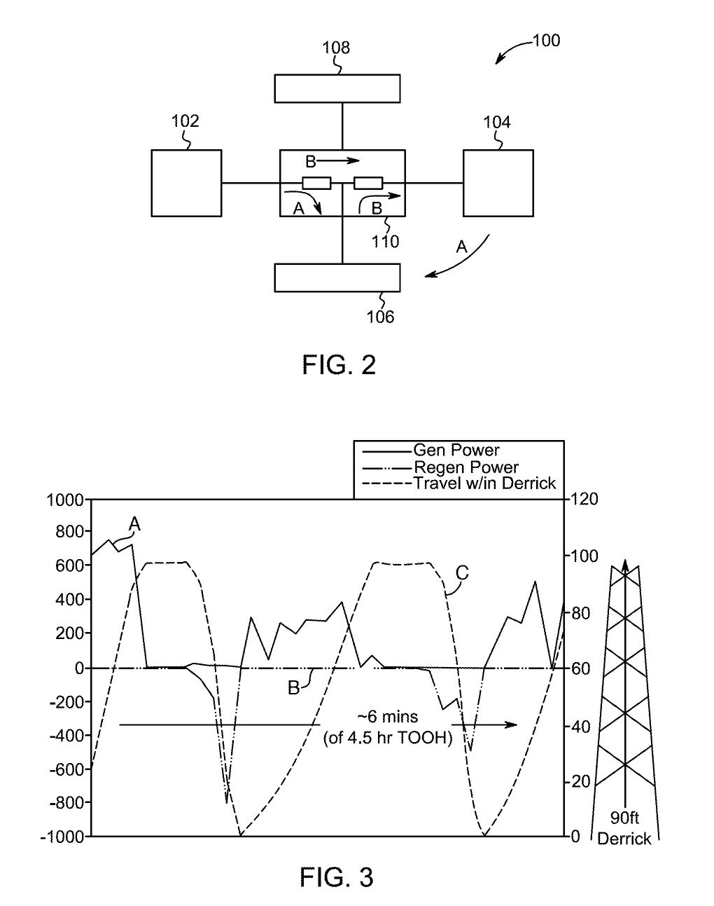

With reference to FIG. 2, a control system 100 for controlling energy storage and distributing regenerated power on a drilling rig is shown. As shown therein, the system 100 includes at least one power source 102, at least one power consuming device 104, at least one power storage device 106, and a control unit 108, all being electrically connected to a common electrical power bus 110. The power source 102 may be one or more combustion generators or the like, such as engine-driven generator 12. Additionally or alternatively, the power source may comprise an electrical power grid (public utility), wind- or solar-based power generators, fuel cell systems, or the like. The power source 102 is utilized to provide electricity to drive various power consuming devices 104, e.g., the working components of the drilling rig such as the draw-works 18, topdrives, mud pumps 26 and gensets, etc. The power storage device may be any type of power storage device known in the art such as batteries of various chemistry and/or storage/discharge capability, flywheels, hydraulic/pneumatic storage, ultra-capacitors, etc. Regardless of the particular means by which the power storage device 106 stores energy (e.g., by hydraulic pressure, rotation/inertia, ultra-capacitor and/or battery storage), the power storage device 106 interfaces with the bus 110 electrically.

The electrical power bus 110 allows electrical power (e.g., volts, amps) to flow between the components connected to the bus 110 (e.g., the power source 102, power consuming devices 104, and storage device 106), providing to, or distributing from the common power bus 110. As shown in FIG. 2, power flow in the direction of arrows B denotes the use of energy by a power consuming device 104. In an embodiment, power may flow, in the direction of arrow B, from a power source 102, through the electrical power bus 110, to a power consuming device 104. Likewise, power may flow, in the direction of arrow B, from a storage device 106, through the electrical power bus 110, to a power consuming device 104. In an embodiment, power may be drawn from both a power storage device 104 and a power source 102, simultaneously, to provide electrical power to a power consuming device 104.

As further shown in FIG. 2, power flow in the direction of arrows A denotes the storing of energy by a power storage device 106. In an embodiment, power may flow, in the direction of arrow A, from a power source 102, through the electrical power bus 110, to a power storage device 106. In another embodiment, power may flow, in the direction of arrow A, from a power consuming device 104 (acting in a power recapture or regeneration mode) to a power storage device 106.

The control unit 108 is configured to control the flow of electrical power in the directions of arrows A and B from the power source 102 to the power consuming devices 104 and to the power storage devices 106. Similarly, the control unit is configured to control the flow of electrical power from the power storage devices 106 to the power consuming devices 104 in instances where supplemental power is needed or where stored energy is available for use. Moreover, the control unit 108 is configured to control the flow of energy from power consuming devices 104 back to the power storage devices 106 in instances where excess energy or recaptured energy, as discussed hereinafter, may be present.

In connection with this, the control unit 108 is configured to control or command the specific linked devices (e.g., the power source 102, power consuming devices 104, and storage device 106) from producers to consumers and vice versa. For example, in an embodiment, the control unit 108 may be configured to command an electrical motor to act as an electrical generator. In another embodiment, the control unit may be configured to command the storage device 106 to switch from providing energy to a power consuming device 104 to storing energy. In an embodiment where the storage device 106 is a battery, the control unit may be configured to command the battery from a battery discharge state (power out) to a battery charging state (power in).

As will be readily appreciated, embodiments of the system 100 are particularly configured for a greater degree of energy efficiency (versus systems not so configured) by either capturing power which may otherwise escape (e.g., the dissipation of electricity to resistor grids/load banks) and/or storing excess power produced. In either or both cases, the system 100 is further configured to then reuse and redistribute this captured or stored electrical power at a later time so as to minimize (or at least reduce) the amount of power generation needed to accomplish a given task, or to maintain the same level of power generation required while decreasing the frequency and/or capacity of power generation necessary to keep up with operating demands.

In an embodiment, the control unit 108 operates according to a control algorithm or control logic that is configured to operate according to two main principles. First, the control unit 108 will control the system 100 to minimize (or at least reduce) energy wasted by methods of energy storage. As used herein, “energy wasted” is defined as heat, inertia, deceleration, gravitational resistance necessary to bring an object to a halt, etc. Second, the control unit 108 will control the system 100 to maximize (or at least increase) the reuse of stored energy back onto the electrical power bus 110 via redistribution to contribute to the consumption requirements of the power consuming devices 104 and to thereby defray the need to generate additional energy to meet such requirements. As used herein, “redistribution” is defined as the reintroduction of stored electrical power from capacitors or other power storage devices, the conversion of stored pressure into rotational input to a generator, conversion of flywheel rotation into electrical power, etc., although other mean of redistribution of stored energy are certainly possible without departing from the broader aspects of the present invention.

Utilizing the system 100 of the present invention, sources of surplus energy on an operating drill rig, for example regenerated power from drill motors driving, or being driven by, draw-works, top drives, mud pumps and gensets, can be stored and redistributed at a later time (or concurrently) toward the energy demands on the drill rig or attending vessels (e.g., platform supply vessels, offshore supply vessels, floating production storage and offloading vessels, or anchor handling units).

The system for controlling energy storage and distributing regenerated power will now be illustrated by way of example. In an embodiment, energy may be captured or regenerated during a tripping operation. As discussed above, drill bits dull after repeated use, becoming less effective, and thereby requiring replacement. In order to replace a drill bit 24, the length of the drill pipe/drill string 20, sometimes miles in length, must be extracted from the well at a rate of one pipe stand 22 at a time, each stand 22 being approximately 90 feet in length and consisting of three sections of pipe of 30 feet each. To extract each pipe stand 22, traveling blocks 16 hold the pipe 22 and move up and down vertically within the derrick 14 for each stand of pipe 22 that is added or subtracted from the drilling string. This reciprocating/elevating action is controlled by the draw-works 18, which is a large cable/drum hoist driven by an electric motor. More specifically, during extraction of a pipe stand 22, the traveling blocks are lowered to the bottom of the derrick 14 where they grip the top of a pipe stand 22. The draw-works 18 then elevate the traveling blocks 16 to the top of the derrick 14, thereby lifting the pipe stand 22 out of the well. Once one pipe stand 22 is extracted from the well, the traveling blocks 16 are accelerated by the force of gravity to the bottom of the derrick 14 to grip the next pipe stand 22 in the string 20. The rapid descent of the swivel/traveling blocks 16 to the bottom of the derrick 14 is often arrested by resistance from the draw-works motor, now switched to function as a generator. This process is repeated until the entire drill string 20 is extracted from the well so that the drill bit 24 is accessible and can be replaced.

As will be readily appreciated, the draw-works 18 motor consumes power when there is a load on the traveling blocks 16 when lifting the drill string 20, but may be the source of regenerative electrical power when lowering the drill string 20 or lowering the traveling blocks 16. That is, the draw-works 18 acts as a motor, as the power consuming device 104, in one mode of operation, and in a second mode of operation acts as a generator for recapturing electrical power. In particular, the raising action requires power consumption while the lowering action, with the assistance of the force of gravity, is a source of power regeneration. In the instant example, during tripping or lowering a pipe stand 22 into the well bore, the force of gravity, with assistance from the rapid pay-out of cable from the draw-works 18, may be utilized to return the traveling blocks 16 to the bottom of the derrick, as discussed above. Once the traveling blocks 16 approach the drill rig platform, however, their fall must be rapidly arrested. In an embodiment, the drill motors, such as the draw-works motor (e.g., an induction motor), may be used to decelerate the rotation of the cable pay-out. In other embodiments, the draw-works motor may be a switched reluctance, permanent magnet, superconduction, or any other motor known in the art, without departing from the broader aspects of the present invention. Accordingly, during this rapid arresting of the traveling blocks, the control unit 108 may command/switch the field of the draw-works motor to act as an electrical generator in order to capture this energy. Normally, this large spike of power would be routed to electrical resistor grids (i.e., load banks) where the energy would be dissipated to the atmosphere as heat, however, the system of the present invention captures the energy and stores it in storage devices 106 for later use.

In particular, power may be regenerated and stored upon each fall and arresting of the traveling blocks within the derrick. As will be readily appreciated, as tripping may take place over a number of hours, substantial energy capture and regeneration may therefore be realized.

FIG. 3 illustrates power usage and power regeneration in relation to the position of the traveling blocks within a derrick during a six minute period of time of a 4.5 hour tripping out of hole cycle. As shown therein, generated power, indicated by line A, is utilized to lift the traveling blocks to the top of a 90 foot derrick in order to lift a pipe stand out of the well bore (the position of the traveling blocks within the derrick and in relation to the drilling platform is indicated by line C). Once the pipe stand is removed, the traveling blocks are released and dropped to the bottom of the derrick via the force of gravity. As the traveling blocks approach the drill rig platform, their free fall is arrested by the draw-works motor, operating as a generator. As denoted by line B, arresting of the traveling blocks in this manner provides for power regeneration. Indeed, as shown therein, power regeneration may be realized from the start of the fall of the traveling blocks until shortly before the traveling blocks reach the platform. Once at the bottom, generated (or stored power) is again utilized to lift the traveling blocks to remove another pipe stand from the well bore, and the process repeats. As shown in FIG. 3, each time the traveling blocks fall from the top of the derrick to the platform, power regeneration may occur. Over the course of an approximately 4.5 hour tripping out of hole cycle, substantial power regeneration may therefore be realized.

As will be readily appreciated, by capturing, storing and reusing energy that would otherwise escape or be released to the environment (e.g., releasing heat through load-banks), less power needs to be produced in order operate all of the power consuming devices on the drill rig. Accordingly, as the amount of power produced is advantageously lowered, unwanted emissions and byproducts associated with power generation are likewise lessened. Indeed, by precisely controlling the use, storage and redistribution of electrical power across the electrical bus, drill rig efficiency, as a whole, may be substantially increased.

In connection with the above, the system of the present invention reduces power generation requirements, thereby reducing emissions from power generation, and reduces the need for load consumption devices that do not add productive work (e.g., load banks). Moreover, the system also provides for reduced frictional and heat related losses due to the capture and reuse of electrical power, even if through other physical means (e.g., chemical, rotational, pneumatic, hydraulic). Accordingly, reduced operating expense, reduced life-cycle costs and reduced environmental impact may be realized.

An embodiment of the present invention relates to a control system. The control system comprises a drill rig having a power consuming device, a power source for providing electrical power, a power storage device, and an electrical power bus. The power bus is electrically connected to the power source, the power consuming device, and the power storage device, and is configured to provide an electrical pathway between one or more of the power source, power consuming device, and power storage device.

In another embodiment of the system, the system includes a control unit electrically coupled to the power bus and configured to selectively control a flow of electrical power between the power source, power consuming device, and power storage device.

In an embodiment, the control unit is configured to control the power source, the power storage device, and the power consuming device for: transfer of the electrical power from the power source to the power consuming device in a first mode of operation (e.g., without concurrent transfer from the power storage device to the power consuming device); transfer of the electrical power from the power storage device to the power consuming device in a second mode of operation (e.g., without concurrent transfer from the power source to the power consuming device); transfer of the electrical power from the power storage device and the power source (e.g., concurrently) to the power consuming device in a third mode of operation; transfer of the electrical power from the power source to the power storage device in a fourth mode of operation; and transfer of electrical power generated by the power consuming device in a power recapture mode of operation, from the power consuming device to the power storage device, in a fifth mode of operation of the control unit.

In an embodiment, the power consuming device comprises one of a draw-works, a top drive, a mud pump, or a genset.

In an embodiment, the power storage device comprises one of a battery, a flywheel, a hydraulic storage device, a pneumatic storage device, or an ultra-capacitor.

In an embodiment, the power source is a combustion generator.

In other embodiments, the power consuming device comprises an induction motor configured to receive the electrical power from the power source or the power storage device and operate as a motor in a first mode of operation, and to operate as a generator for recapturing electrical power in a second mode of operation.

In an embodiment, the drill rig further comprises a derrick, a draw-works comprising the induction motor, and traveling blocks operably coupled to the induction motor for raising and lowering a drill string into and out of a well bore. In such an embodiment, the induction motor, in the second mode of operation, is configured to generate the electrical power through arresting the fall of the traveling blocks within the derrick during a tripping process and transfer the electrical power that is generated to the power storage device for storage.

In another embodiment, a method for a drill rig is provided. The method includes controlling a flow of electrical power from a power source to a power consuming device of the drill rig, and storing electrical power in excess of that consumed by the power consuming device in a power storage device.

In an embodiment, the method includes the step of recapturing electrical power from the power consuming device, and storing the electrical power that is recaptured in the power storage device.

In an embodiment, the method may also include the step of redistributing the recaptured electrical power from the power storage device to the power consuming device or another power consuming device.

In an embodiment, the power storage device comprises a battery configured for storage and discharge of the electrical power. In such an embodiment, the method further includes the steps of controlling the battery from a power storage state, in which the electrical power is stored by the battery, to a power discharge state, in which the electrical power is discharged by the battery, and controlling the flow of electrical power from the battery to the power consuming device.

In an embodiment, the method may further include the step of selectively controlling the flow of electrical power from the power source to the power consuming device, from the power source to the power storage device and from the power storage device to the power consuming device in dependence upon the power generation capacity of the power source and the amount of power required by the power consuming device.

In another embodiment, the power source, power consuming device and power storage device are electrically coupled to an electrical power bus enabling the selective flow of electrical power therethrough.

In an embodiment, the power source comprises an electrical motor/generator operating in a first, power generation mode and is controllable to operate in a second, power recapture mode. In such an instance, the method may also include the step of controlling the electrical motor/generator from the first mode to the second mode.

In an embodiment, the drill rig includes a derrick, a draw-works and traveling blocks for raising and lowering a drill string into and out of a well bore, and the step of recapturing electrical power includes utilizing an induction motor to arrest the fall of traveling blocks within the derrick during a process of tripping. In an embodiment, the step of recapturing the electrical power comprises an induction motor generating the electrical power under action of the traveling blocks falling during a tripping process of the drill rig.

Another embodiment of the present invention relates to a control system. The control system comprises a source of electrical power, a drill rig having a power consuming implement, a power storage unit, an electrical power bus, and a control unit. The electrical power bus is electrically coupled to the source of electrical power, the power consuming implement and the power storage unit, and is configured to provide an electrical pathway between one or more of the source of electrical power, the power consuming implement, and the power storage unit. The control unit is electrically coupled to the power bus and is configured to selectively control the flow of electrical power between the source of electrical power, the power consuming implement, and the power storage device.

In an embodiment, the control unit is configured to selectively control the flow of electrical power from the source to the power consuming implement, from the source to the power storage unit, and from the power storage unit to the power consuming implement in dependence upon a power generation capacity of the source of electrical power and an electrical power demand of the power consuming implement.

In an embodiment, the source of electrical power may be a motor that is capable of operating in a power generation mode and a power recapture mode, and the control unit may be configured to control the motor between the power generation mode and power recapture mode.

In another embodiment, the power storage unit is a battery having a battery discharge mode and a battery charging mode. The control unit may be configured to control the battery between the battery discharge mode, in which electrical power flows from the battery to the power consuming implement, to the battery charging mode, in which recaptured energy is stored in the battery.

In yet another embodiment of the present invention, a control system is provided. The control system comprises a drill rig having a derrick, a draw-works, and traveling blocks for raising and lowering a drill string into and out of a well bore, wherein the draw-works comprises a motor operably coupled to the traveling blocks, a power source at a site of the drill rig for providing electrical power, a power storage device at the site of the drill rig, an electrical power bus electrically connected to the power source, the motor, and the power storage device, and a control unit electrically coupled to the power bus. The control unit is configured to control transfer of at least a portion of the electrical power provided by the power source to the power storage device over the electrical power bus when a capacity of the power source exceeds a power demand of the motor and other loads connected to the power source; control transfer of the electrical power provided by the power source to the motor over the electrical power bus for the motor to raise the traveling blocks; and control transfer of electrical power generated by the motor, from the motor to the power storage device over the electrical power bus, when the motor arrests the fall of the traveling blocks within the derrick during a tripping process of the drill rig.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the system for controlling energy storage and distributing regenerated power, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A control system, comprising:
a drill rig having a power consuming device;
a power source for providing electrical power;
a power storage device; and
an electrical power bus electrically connected to the power source, the power consuming device, and the power storage device and configured to provide an electrical pathway between one or more of the power source, power consuming device, and power storage device.

2. The system of claim 1, further comprising:
a control unit electrically coupled to the power bus and configured to selectively control a flow of electrical power between the power source, power consuming device, and power storage device.

3. The system of claim 2, wherein:
the control unit is configured to control the power source, the power storage device, and the power consuming device for: transfer of the electrical power from the power source to the power consuming device in a first mode of operation; transfer of the electrical power from the power storage device to the power consuming device in a second mode of operation; transfer of the electrical power from the power storage device and the power source to the power consuming device in a third mode of operation; transfer of the electrical power from the power source to the power storage device in a fourth mode of operation; and transfer of electrical power generated by the power consuming device in a power recapture mode of operation, from the power consuming device to the power storage device, in a fifth mode of operation of the control unit.

4. The system of claim 1, wherein:
the power source is a combustion generator.

5. The system of claim 1, wherein:
the power consuming device comprises one of a draw works, a top drive, a mud pump, or a genset.

6. The system of claim 1, wherein:
the power storage device comprises one of a battery, a flywheel, a hydraulic storage device, a pneumatic storage device, or an ultra-capacitor.

7. The system of claim 1, wherein:
the power consuming device comprises an induction motor configured to receive the electrical power from the power source or the power storage device and operate as a motor in a first mode of operation, and to operate as a generator for recapturing electrical power in a second mode of operation.

8. The system of claim 7, wherein:
the drill rig further comprises a derrick, a draw-works comprising the induction motor, and traveling blocks operably coupled to the induction motor for raising and lowering a drill string into and out of a well bore; and
wherein the induction motor, in the second mode of operation, is configured to generate the electrical power through arresting the fall of the traveling blocks within the derrick during a tripping process and transfer the electrical power that is generated to the power storage device for storage.

9. A method for a drill rig, the method comprising the steps of:
controlling a flow of electrical power from a power source to a power consuming device of the drill rig; and
storing electrical power in excess of that consumed by the power consuming device in a power storage device.

10. The method according to claim 9, further comprising the step of:
recapturing electrical power from the power consuming device; and
storing the electrical power that is recaptured in the power storage device.

11. The method according to claim 9, further comprising the step of:
redistributing the recaptured electrical power from the power storage device to the power consuming device or another power consuming device.

12. The method according to claim 9, wherein:
the power storage device comprises a battery configured for storage and discharge of the electrical power; and
the method further includes the steps of controlling the battery from a power storage state, in which the electrical power is stored by the battery, to a power discharge state, in which the electrical power is discharged by the battery, and controlling the flow of electrical power from the battery to the power consuming device.

13. The method according to claim 9, further comprising the step of:
selectively controlling the flow of electrical power from the power source to the power consuming device, from the power source to the power storage device, and from the power storage device to the power consuming device in dependence upon a power generation capacity of the power source and an amount of power required by the power consuming device.

14. The method according to claim 9, wherein:
the power source, power consuming device, and power storage device are electrically coupled to an electrical power bus enabling the selective flow of electrical power therethrough.

15. The method according to claim 14, wherein:
the power source comprises an electrical motor/generator operating in a first, power generation mode and controllable to operate in a second, power recapture mode; and
the method further includes the steps of controlling the electrical motor/generator from the first mode to the second mode.

16. The method according to claim 10, wherein:
the drill rig includes a derrick, a draw-works, and traveling blocks for raising and lowering a drill string into and out of a well bore; and
the step of recapturing the electrical power includes utilizing an induction motor to arrest the fall of traveling blocks within the derrick during a process of tripping.

17. The method according to claim 10, wherein:
the drill rig includes a derrick, a draw-works, and traveling blocks for raising and lowering a drill string into and out of a well bore; and
the step of recapturing the electrical power comprises an induction motor generating the electrical power under action of the traveling blocks falling during a tripping process of the drill rig.

18. A control system, the system comprising:
a source of electrical power;
a drill rig having a power consuming implement;
a power storage unit;
an electrical power bus electrically coupled to the source of electrical power, the power consuming implement, and the power storage unit and configured to provide an electrical pathway between one or more of the source of electrical power, the power consuming implement, and the power storage unit; and
a control unit electrically coupled to the power bus, the control unit being configured to selectively control a flow of the electrical power between the source of electrical power, the power consuming implement, and the power storage device.

19. The system of claim 18, wherein:
the control unit is configured to selectively control the flow of electrical power from the source to the power consuming implement, from the source to the power storage unit, and from the power storage unit to the power consuming implement in dependence upon a power generation capacity of the source of electrical power and an electrical power demand of the power consuming implement.

20. The system of claim 18, wherein:
the source of electrical power is a motor capable of operating in a power generation mode and a power recapture mode; and
wherein the control unit is configured to control the motor between the power generation mode and the power recapture mode.

21. The system of claim 18, wherein:
the power storage unit is a battery, the battery having a battery discharge mode and a battery charging mode; and
wherein the control unit is configured to control the battery between the battery discharge mode, in which electrical power flows from the battery to the power consuming implement, to the battery charging mode, in which recaptured energy is stored in the battery.

22. A control system, the system comprising:
a drill rig having a derrick, a draw-works, and traveling blocks for raising and lowering a drill string into and out of a well bore, wherein the draw-works comprises a motor operably coupled to the traveling blocks;
a power source at a site of the drill rig for providing electrical power;
a power storage device at the site of the drill rig;
an electrical power bus electrically connected to the power source, the motor, and the power storage device; and
a control unit electrically coupled to the electrical power bus and configured to: control transfer of at least a portion of the electrical power provided by the power source to the power storage device over the electrical power bus when a capacity of the power source exceeds a power demand of the motor and other loads connected to the power source; control transfer of the electrical power provided by the power source to the motor over the electrical power bus for the motor to raise the traveling blocks; and control transfer of electrical power generated by the motor, from the motor to the power storage device over the electrical power bus, when the motor arrests the fall of the traveling blocks within the derrick during a tripping process of the drill rig.
